(19) United States
(12) Patent Application Publication
(10) Pub. No.: US 2015/0244856 A1
(43) Pub. Date: Aug. 27, 2015

(54) INTERNATIONAL DIALING THROUGH CALL CONNECTIONS

(71) Applicant: Talk.to FZC, Ras Al Khaimah (AE)

(72) Inventor: Bhavin Turakhia, Mumbai (IN)

(21) Appl. No.: 14/296,112

(22) Filed: Jun. 4, 2014

(30) Foreign Application Priority Data
Feb. 27, 2014 (IN) 696/MUM/2014

(51) Int. Cl. H04M 3/22; H04W 4/12; H04M 3/42

(52) U.S. Cl. CPC H04M 3/229; H04M 3/4228; H04W 4/12; H04W 4/14

(57) ABSTRACT

In example embodiments, a system and method for international dialing through call connections is provided. An indication of an initiation of a call by a first user to a second user is received. A first pool number is provided to the first user, whereby the first pool number is different from a phone number of the second user. A message is transmitted to the second user that triggers the second user device to automatically initiate a second call to a second pool number, whereby the second pool number is different from a phone number of the first user. A first call via the first pool number and the second call via the second pool number are received. Based on a call parameter, a determination is made to connect the first call and the second call, and the first call is connected to the second call.

### CROSS-REFERENCE TO RELATED APPLICATIONS

The present application claims the benefit of priority under 35 U.S.C. §119 to Indian Application No. 696/MUM/2014, filed on Feb. 27, 2014, which is incorporated herein by reference in its entirety.

### FIELD

The present disclosure relates generally to communications, and in a specific example embodiment, to providing dialing through call connections.

### BACKGROUND

When a user wants to call an individual internationally using their mobile device, the user dials the international phone number of the individual. The cost for the call to the individual will typically cost more than a domestic or local call for the user. While some systems allow for cheaper calls using Voice-over-IP (VoIP), VoIP is typically available only where the mobile device has a good Internet connection. Additionally, the call quality of a VoIP call may be sometimes problematic.

### BRIEF DESCRIPTION OF DRAWINGS

Various ones of the appended drawings merely illustrate example embodiments of the present invention and cannot be considered as limiting its scope.

FIG. 1 is a diagram illustrating an example environment in which embodiments of a system for dialing through call connections may be implemented.

FIG. 2 is a block diagram illustrating an example embodiment of a user device.

FIG. 3 is a block diagram illustrating an example embodiment of a service provider system.

FIG. 4A is an example communication flow diagram for international dialing through call connections according to one embodiment.

FIG. 4B is an example communication flow diagram for international dialing through call connections according to another embodiment.

FIG. 4C is an example communication flow diagram for international dialing through call connections according to another alternative embodiment.

FIG. 4D is an example communication flow diagram for international dialing through call connection according to a further alternative embodiment.

FIG. 4E is an example communication flow diagram for international dialing through call connections according to another alternative embodiment.

FIG. 4F is an example communication flow diagram for international dialing through call connections according to another alternative embodiment.

FIG. 4G is an example communication flow diagram for international dialing through call connections according to a further alternative embodiment.

FIG. 5 is a flow diagram of an example method for providing international dialing through call connections.

FIG. 6 is a simplified block diagram of a machine in an example form of a computing system within which a set of instructions for causing the machine to perform any one or more of the methodologies discussed herein may be executed.

### DETAILED DESCRIPTION

The description that follows includes systems, methods, techniques, instruction sequences, and computing machine program products that embody illustrative embodiments of the present invention. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Example embodiments described herein provide systems and methods for providing dialing (e.g., international dialing) through call connections. An indication of an initiation of a call by a first user to a second user is received by a service provider system. A first pool number is provided to the first user, whereby the first pool number is different from a phone number of the second user. A message may be transmitted to the second user that causes a second user device to automatically initiate a call to a second pool number without any action by the second user. A first call via the first pool number and a second call via the second pool number are received by the service provider system. Subsequently, the first call is connected to the second call. As such, a potentially expensive international call is converted into relatively inexpensive two local calls (e.g., local to each respective user).

In some embodiments, a communication application may be provided on the user devices of the first user and the second user. The communication application can provide functionalities or advantages over a native calling application on the user device. For example, the use of the communication application may allow for a lower rate or lower cost on international communications (e.g., calls, text messages, or chat messages) such that whenever the user tries to initiate an international call, the communication application requests and obtains the pool number for local calling (e.g., in a local calling area relative to the user). The pool number may comprise a low cost alternative relative to calling the long distance number since the local number may be in a same area code as the user (and thus is a domestic low or no cost number). Additionally, the communication application may send messages to the other user that triggers the user device of the other user to automatically initiate a call to their respective pool number.

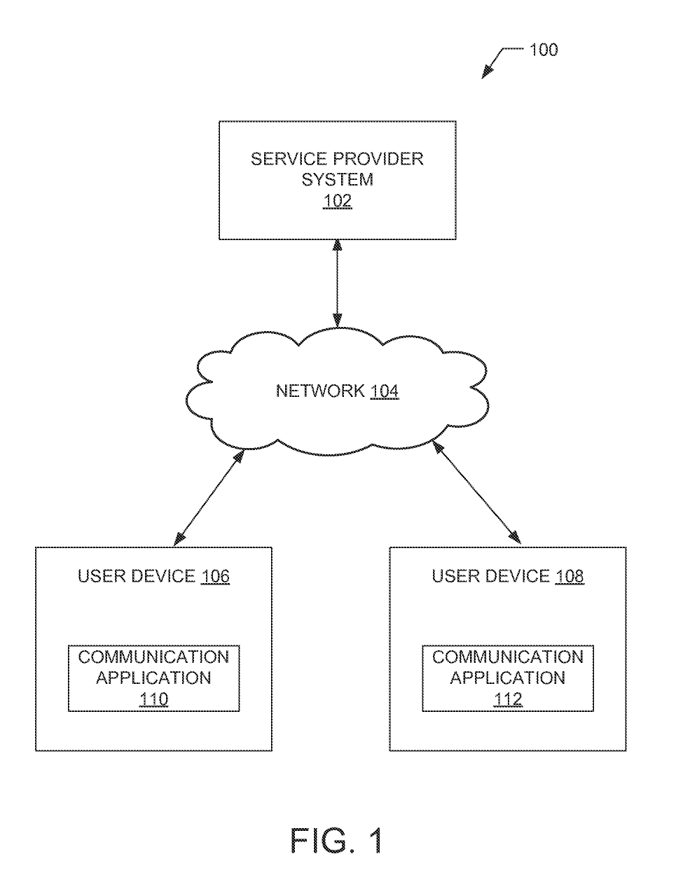

With reference to FIG. 1, a diagram illustrating an example environment 100 in which embodiments of a system for international dialing through call connection is provided. The environment 100 comprises a service provider system 102 coupled via a network 104 (e.g., the Internet, wireless network, cellular network, PSTN, or a Wide Area Network (WAN)) to a first user device 106 and a second user device 108. The first user device 106 is associated with a first user that is attempting to place an international call. In example embodiments, the first user may have downloaded or otherwise installed a communication application 110 on their user device 106 that communicates with the service provider system 102. The user device 106 may also have a native calling application for providing communication services. Thus, the user device 106 may comprise multiple applications for use in initiating a communication, and the user has an option to use any of the applications. The user device 106 may comprise a mobile phone, smartphone, laptop, tablet, or any other communication device that a user may utilize to store, access, or operate the communication application 110.

The second user device 108 is associated with a second user that may be a call recipient of the first user. In some embodiments, the second user may have downloaded or otherwise installed a communication application 112 on their user device 108 that communicates with the service provider system 102. The user device 108 may also have a native calling application for providing communication services. Thus, the user device 108 may comprise multiple applications for use in initiating a communication. The user device 108 may comprise a mobile phone, smartphone, laptop, tablet, or any other communication device that a user may utilize to store, access, or operate the communication application 112.

The communication applications 110 and 112 comprise pieces of functionality on the user devices 106 and 108 that provide functions or operations that allow the users of the user devices 106 and 108 to conduct an international call using call connections by the service provider system 102, as will be discussed in more detail below. In some embodiments, the service provider system 102 may provide the communication applications 110 and 112 to the respective user devices 106 and 108 (e.g., provide a downloadable version of the service application, electronically send the service application to the user device 106, or physically send to the user via a storage medium such as a CD ROM). Some embodiments may be practiced without the use of the communication application 110 on (e.g., being stored by, or being executed by) the user device 106 or the communication application 112 on the user device 108.

It is noted that the environment 100 shown in FIG. 1 is merely an example. For example, alternative embodiments may comprise any number of user devices 106 and 108 in the environment 100 and any number of service provider systems 102.

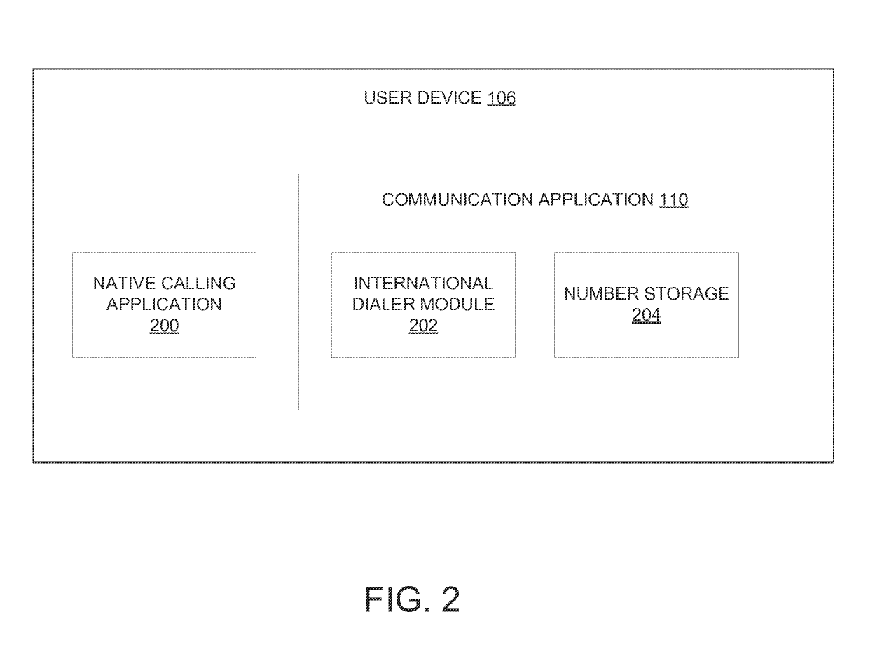

Referring now to FIG. 2, a block diagram illustrating an example embodiment of the user device 106 of the first user is shown. The user device 106 is illustrated having the communication application 110 installed thereon. The user device 106 may also include a native calling application 200. In some embodiments the communication application 110 and the native calling application 200 may be one and the same. The communication application 110 may provide enhanced communication functionality and services to the user device 106. The communication application 110 may also initiate an international call to the service provider system 102. Accordingly, the communication application 110 may comprise an international dialer module 202 and a number storage 204. It is noted that the user device 106 and the communication application 110 may comprise other modules not pertinent to example embodiments that are not shown or discussed.

The international dialer module 202 manages communications initiated by the user device 106 that are directed to international calling. Upon activation of the communication application 108, the international dialer module 202 allows the user of the user device 106 to dial an international number of a callee (e.g., the second user) or select the international number for the callee from stored contact information (e.g., from the number storage 204). Once the international number is entered and a call initiated (e.g., selecting a “dial” or “talk” button) from within the communication application 110, the international dial module 202 may send a request to the service provider system 102 requesting a local pool number. Alternatively, if the local pool number has been previously assigned to the user device 106 for the selected international number, the international dialer module 206 may take the selected international number and check for the local pool number in the number storage 204. In yet a further embodiment, if the user attempts to dial the international number using the native call application 200, the communication application 110 may intercept the call and the international dialer module 202 may either send the request for the local pool number or perform a lookup in the number storage 204 for a previously stored local pool number that corresponds to the dialed international number. Once the local pool number is obtained by the international dialer module 202, the international dialer module 202 dials the local pool number. While example embodiments are discussed with respect to international calls, alternative embodiments may be directed to other forms of calls. For example, the call may be a long distance call within the same country.

In various embodiments, the user device 108 of the second user may also comprise a similar communication application (e.g., communication application 112). The communication application 112 at the second user device 108 may receive a message to call a second pool number (e.g., local number that is local to the second user) in response to the call initiated by the first user. The communication application 112 may, in some embodiments, automatically dial the second pool number in response to receiving the message.

In an alternative embodiment, the second user device 108 may not comprise a communication application 110. In these embodiments, the second user device 108 may receive the message via SMS or audio messaging (e.g., an automated call from the service provider system 102). The message may instruct the second user to call, using the native call application on the user device 108, the local/second pool number of the second user. Additionally, even if the second user device 108 comprises a communication application 110, the message may still be sent via SMS or audio messaging.

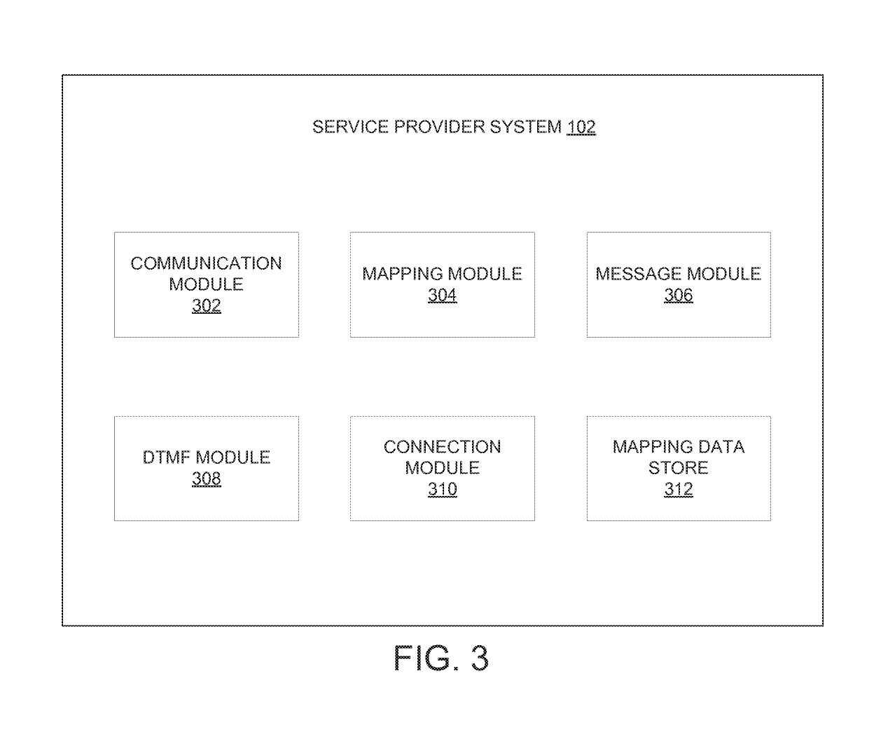

Referring now to FIG. 3, the service provider system 102 is shown in more detail. In example embodiments, the service provider system 102 may comprise one or more servers that provide communication functionalities and services including international dialing through call connections to users having the communication application 108 installed on their user device. To enable these functionalities and services, the service provider system 102 may comprise a communication module 302, mapping module 304, a message module 306, a DTMF module 308, a connection module 310, and a mapping data store 312 coupled in communication with each other. The service provider system 102 may comprise other components not pertinent to example embodiments that are not shown or discussed. Furthermore, alternative embodiments may comprise more, less, multiples of, or other modules for providing international dialing through call connections. Additionally, some functions of the modules may be combined or divided into two or more further modules.

The communication module 302 manages reception and responses for requests and calls from various user devices. In example embodiments, the communication module 302 receives an indication of a call from the first user to the second user. In some instances, the indication may indicate that the first user is attempting to call the second user using the international number for the second user and may include a request for a pool number that is in a local calling area (e.g., in a same area code or lower cost than a long distance number) to the first user (referred to as the “first pool number”). In other instances, the indication may indicate that the first user is calling the second user using a previously assigned first pool number (stored at the first user device 108) that corresponds to the international number for the second user. If the indication includes the request for the first pool number, the communication module 302 may obtain the pool number via the mapping module 304 and return the first pool number to the first device of the first user. In one embodiment, the first pool number may be returned to the communication application 110 on the user device 106. In alternative embodiments, the pool number may be returned using SMS, an audio call, or any other form of communication. In an alternative embodiment, the indication of the call may be received by the communication application 110 of the first user device 106, and the communication application 110 may provide a message to the second user device 108 as is discussed in more detail below.

In some embodiments, the communication module 302 may also receive requests to pre-assign pool numbers to the first device 108 from the communication application 110. For example, when the user initially downloads or installs the communication application 110 on their user device 108, the communication application 110 may request that all international numbers in a contact list (e.g., address book) on the user device 108 be pre-assigned a pool number by sending such a request to the service provider system 102. Additionally, each time a new contact is added to the contact list or modified that is associated with an international number, the communication module 302 may receive a request from the communication application 110 to pre-assign a pool number to that international number.

The mapping module 304 manages the pool numbers at the service provider system 102. In example embodiments, the mapping module 304 determines a pool number to assign to a user that is local to the user. For example, the mapping module 304 may assign a pool number in the same area code as the user. If there is no pool number in the same area code, the mapping module 304 may assign a pool number that is the least expensive for the user to call. Once the pool number is assigned, the mapping module 304 may store the pool number along with related attributes. The related attributes may include one or more of a user identifier corresponding to the user (e.g., phone number of the user device 106 of the first user), the corresponding international number, a time that the pool number was assigned, an expiration time for the pool number, a corresponding pool number assigned to the second user, and so forth. The related attributes may be used in comparing with a parameter of a call to a pool number in order to determine a proper connection to be made between two calls, as will be discussed in more detail below.

In an alternative embodiment, the mapping may be performed by the international dialer module 202. For example, the communication application 110 may obtain a plurality of available pool numbers via the communication module 302 and mapping module 304. The international dialer module 202 maps a pool number to each international number in the contact list, and sends the mapping back to the service provider system 102. The communication module 302 receives the mapping and the mapping module 304 may store the mapping to the mapping data store 312.

The message module 306 causes a first message to be sent to the second user based on an indication that the first user is attempting to call the second user. In some embodiments, when the communication module 302 receives the indication of the call from the first user to the second user, the message module 306 may send the first message to the user device 108 of the second user (e.g., using the international number of the second user). The first message may comprise a request to the second user device 108 to initiate a call in order to be connected with the first user. In example embodiments, the request in the first message may trigger the second user device (e.g., the communication application 112) to automatically call, without human intervention, a second pool number provided to the second user device 108. In alternative embodiments, the first message may be sent by the communication application 110 (e.g., international dialer module 202) of the first user device 106. For example, the communication application 110 on the first user device 106 may initiate the call to the second user and send the first message to the second user substantially simultaneously, or the first message may be sent after the first user device 106 receives the first pool number or dials the first pool number. The first message may be sent in real-time, via SMS, via an audio call, or via the Internet in various embodiments. In some embodiments, the first message may be sent to the communication application 112 on the second user device 108. Additionally, the first message may be sent prior to the first user initiating the call to the first pool number or after the first user initiates the call to the first pool number.

In some cases, the first message may include a second pool number for the second user to call. The second pool number may be a local number relative to the second user. For example, the message module 306 may send both the first message and the pool number to the second user together. Alternatively, the second pool number may be sent separate from the first message. For example, the communication application 110 of the first user device 106 may send the first message while the message module 306 of the service provider system 102 sends the second pool number to the second user, or the message module 306 sends the first message and the second pool number as two separate communications.

In any of these embodiments, the second pool number may be obtained from the mapping module 304. The mapping module 304 may assign the second pool number in the same area code as the user or that is the least expensive (of available pool numbers) for the second user to call. Once the second pool number is assigned, the mapping module 304 may store the second pool number along with related attributes (e.g., a user identifier corresponding to the second user, the corresponding international number, a time that the second pool number was assigned, an expiration time for the second pool number, user identifier of the first user, first pool number) in the mapping data store 312. In an alternative embodiment, the communication application 112 at the second user device 108 may map the second pool number. For example, available pool numbers may be provided to the communication application 112. The communication application 112 maps one of the pool numbers an international number (e.g., the number of the first user that is attempting to call the second user), and sends the mapping back to the service provider system 102. The communication module 302 receives the mapping and the mapping module 304 may store the mapping to the mapping data store 312.

In some embodiments, the message module 306 may send a second message to the first user in response to an action performed on the second user device 108. For example, the second message may be sent upon the second user at the second user device 108 receiving the first message, the second call being initiated by the second user device 108, or the second user acknowledging the request in the first message. Alternatively, the second user device 108 may send the second message directly to the first user device 106. In one embodiment, the first user device 106 may not place a call to the first pool number until it has received the second message. In another embodiment, the first user device 106 may place the first call but the service provider system 102 may not pick up the first call. Instead, the service provider system 102 allows the first call to ring until, for example, the second message has been transmitted or received by the first user or is acknowledged by the first user. Further still, the communication application 110 on the first user device 106 may, in one embodiment, automatically call the first pool number in response to receiving the second message. This call sequence ensures that the second user device 108 is available before the first user device 106 calls the first pool number.

The DTMF module 308 analyzes dual-tone multi-frequency signaling (DTMF) tones received with a call to extract information. For example, the first call made by the first user device 106 to the first pool number may comprise DTMF tones that indicate a parameter, data, or code that maps the first call to the second call from the second user device 108 using the corresponding second pool number. For instance, the DTMF tone from the first call may indicate the user identifier of the second user or the second pool number to which the first call should be connected.

The connection module 310 manages the connection of calls received via pool numbers and determines whether to connect the calls or which calls are to be connected. In some embodiments, the connection module 310 may determine, receive, or extract at least one call parameter associated with at least one of the first call of the second call. The call parameter is then used to map the first call to a second call from the second user. The call parameter may include, for example, the user identifier of the first user, the user identifier of the second user, the first pool number of the first call, and the second pool number of the second call that should be connected to the first call. Using at least one of these call parameters, the connection module 310 may access the mapping data store 312 to determine a mapping for the first call to the second call. For example, if the call parameter comprises the user identifier of the first user, the connection module 310 may determine, from the mapping data store 312, the second pool number that corresponds to the user identifier of the first user. Thus, when a second call via the second pool number is received by the connection module 310, the connection module 310 knows to connect these two calls. In alternative embodiments, the connection module 310 may be able to determine which calls to connect without having to access the mapping data store 312. Instead, the parameter obtained from the calls may be enough in themselves to indicate which calls to connect.

In some embodiments, the call parameters may be determined from DTMF tones received with the first call and/or the second call. In other embodiments, the call parameters may be determined from data received from the communication application (e.g., communication application 110). In some embodiments, the data from the communication application may be received separate from the first call or the second call. For example, the communication application 110 may call the first pool number while also sending data via SMS or over the Internet to the service provider system 102.

The mapping data store 312 may comprise a database of tables having tuples of attributes which indicate which pool number calls to connect. For example, a tuple may include the first pool number, the second pool number, the user identifier of the first user, and the user identifier of the second user. In another example, the tuple may include the first pool number, the second pool number, the user identifier of the second user, and an expiration time for the pool numbers. It is noted that each tuple may comprise any number of attributes and that the attributes may be any call parameter that is identifiable from the calls, data received from DTMF tones, or data received from the communication application 110 or 112. Additionally, because pool numbers are mapped to call parameters corresponding to the particular users or their user identifiers, the same pool number may assigned to different users.

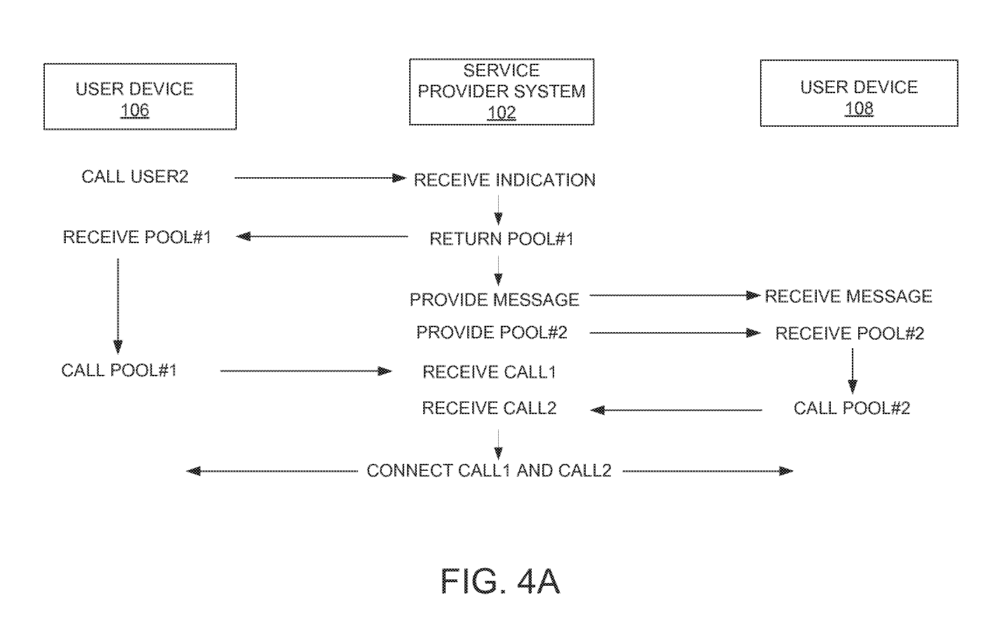

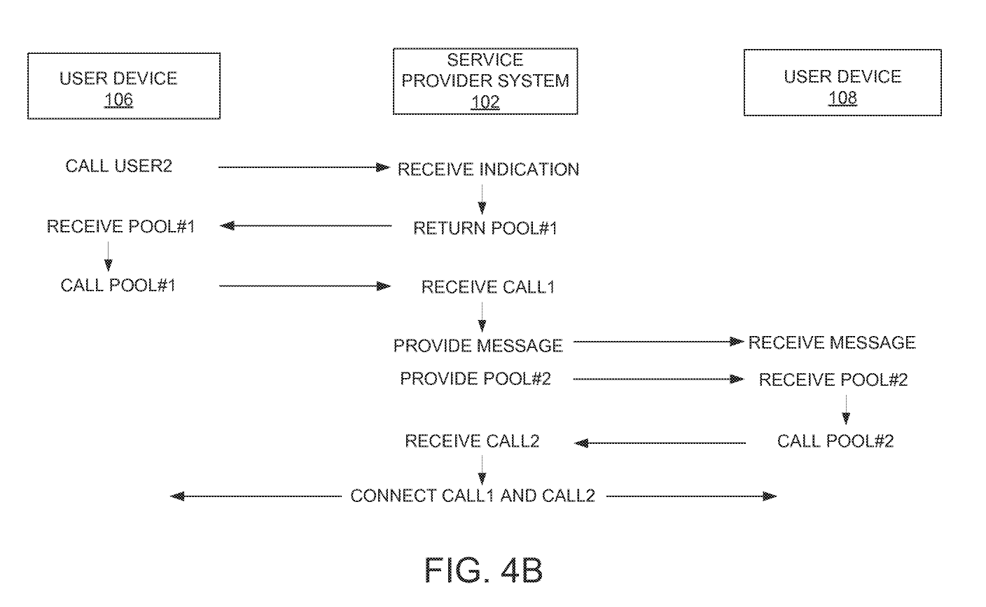

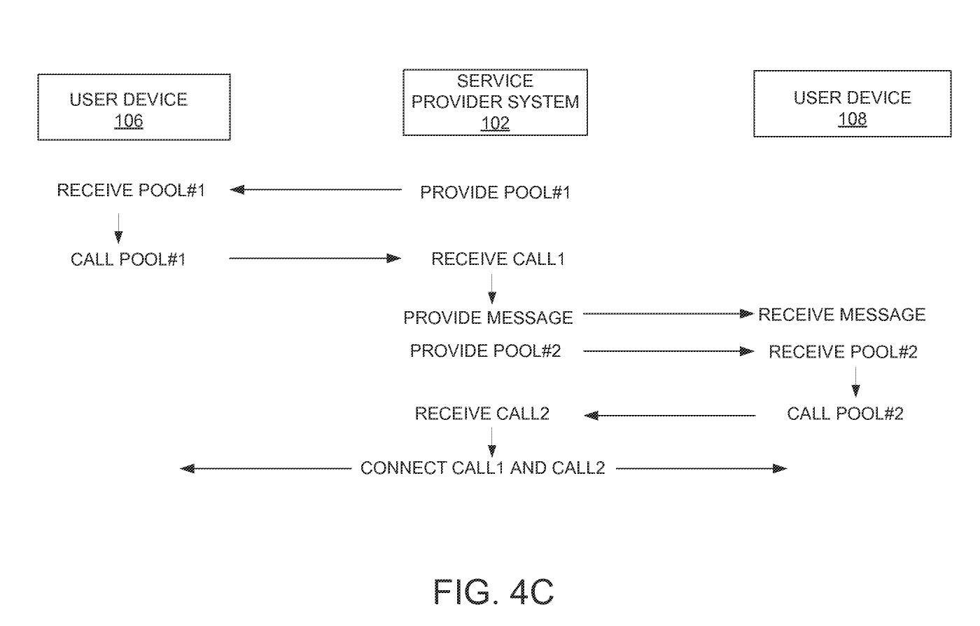

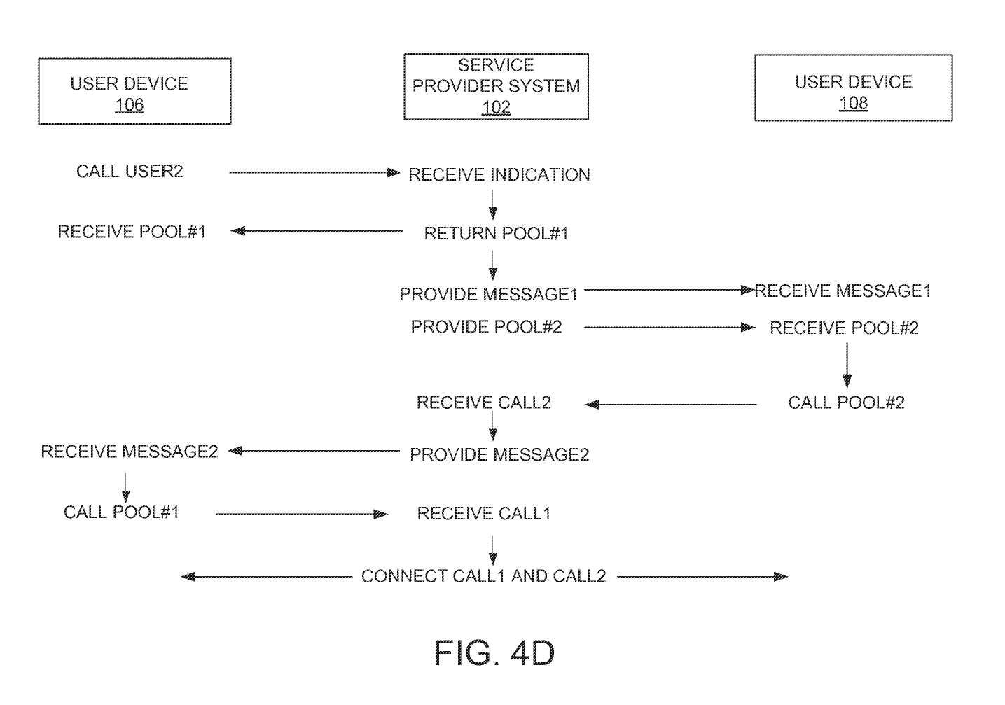

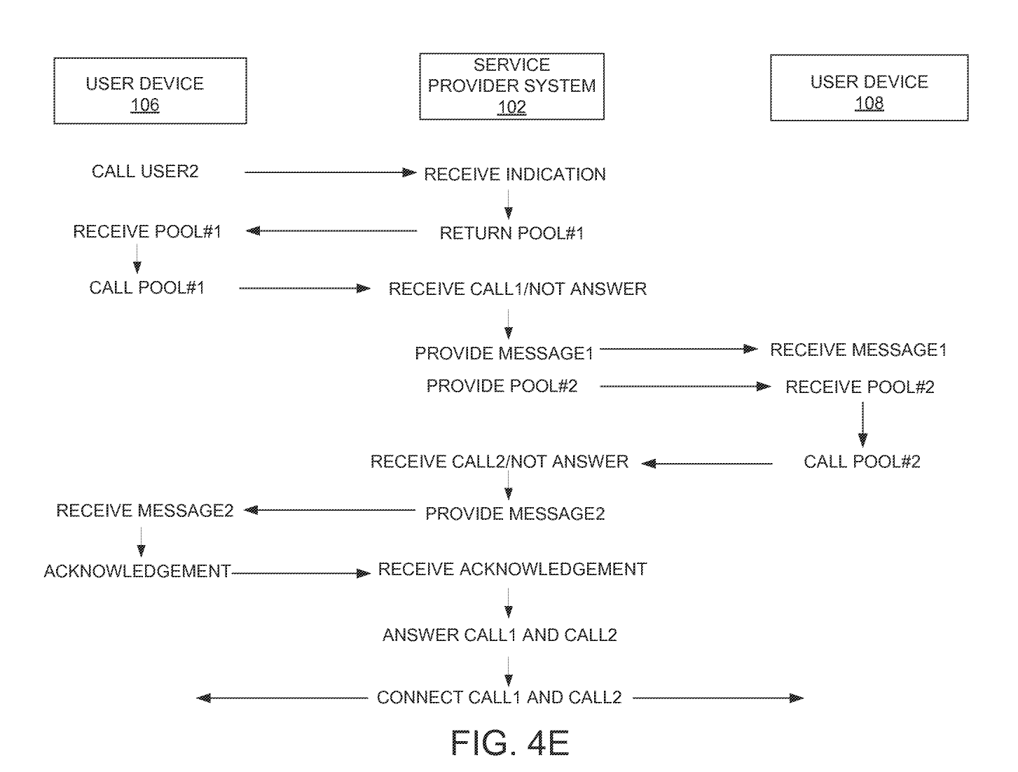

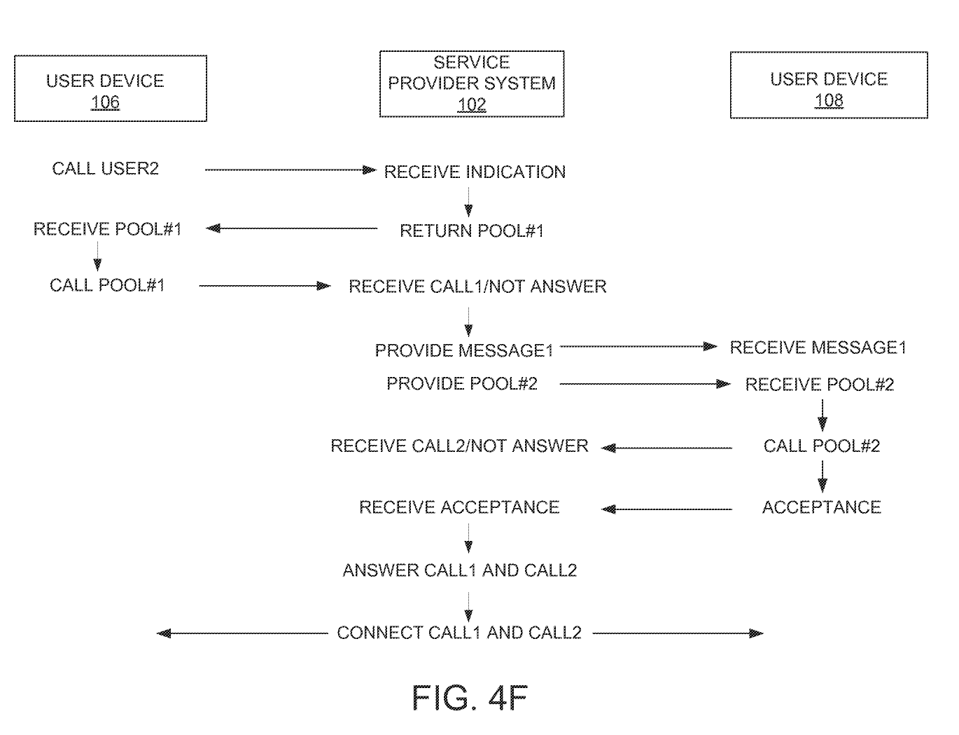

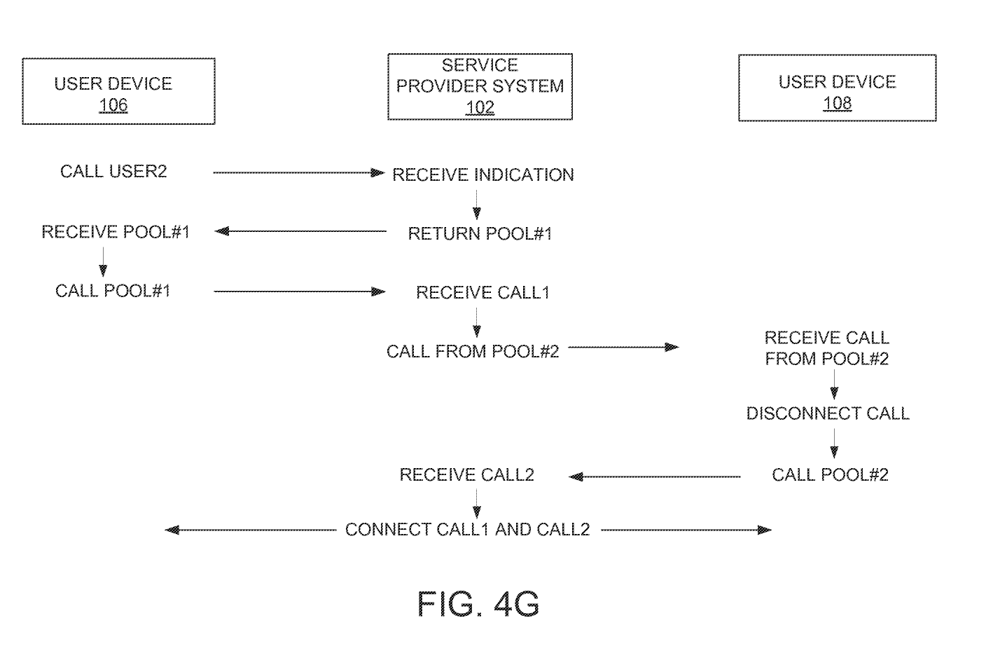

FIG. 4A is an example communication flow diagram for international dialing through call connections according to one embodiment. The embodiment of FIG. 4A assumes that the first user device 106 does not have a pre-assigned pool number for calling the second user. Accordingly, a user at the first user device 106 (referred to as “user1”) initiates a call to the second user (referred to as “user2”). For example, user1 may dial an international number for user2 or select user2 from a contact list. An indication of the call is received by the service provider system 102. The indication may be sent, for example by the communication application 110 and include a request for a first pool number.

In response, the service provider system 102 returns a first pool number (referred to as “pool#1”) to user1. Substantially simultaneously with the receiving of the indication the service provider system 102 sends a message to user2 at the second user device 108.

The message may include a second pool number (referred to as “pool#2) or pool#2 may be sent separately. In example embodiments, the second user device 108 (e.g., the communication application 112) may automatically call pool#2 in response to receiving the message (and pool#2).

While the message was being sent to user2 at the second user device 108 (or after the message is sent), the first user device 106 of user1 may call pool#1. The service provider system 102 receives both call1 via pool#1 and call2 via pool#2. The service provider system 102 makes a determination to connect call1 and call2 (e.g., based on at least one call parameter) and connects call1 and call2.

While the embodiment of FIG. 4A shows the service provider system 102 sending the message to the second user device 108 of user2, alternatively, the communication application 110 on the first user device 106 may send the message. Thus, the communication application 110 may send the message after it receives pool#1 in FIG. 4A. In yet another embodiment, the communication application 120 on the first user device 106 may send the message with or after the initiation of the call to user2, and the service provider system 102 may send pool#2 any time after the sending of the message.

FIG. 4B is an example communication flow diagram for international dialing through call connections according to another embodiment. The embodiment of FIG. 4B also assumes that the first user device 106 does not have a pre-assigned pool number for calling the second user. Accordingly, user1 at the first user device 106 initiates a call to user2. For example, user1 may dial an international number for user2 or select user2 from a contact list. An indication of the call is received by the service provider system 102. The indication may be sent, for example by the communication application 110 and include a request for a first pool number.

In response, the service provider system 102 returns pool#1 to user1. However, unlike the embodiment of FIG. 4A, the service provider system 102 does not send the message to user2 until the service provider system receives call1 via pool#1. Once call1 is received, the service provider system 102 sends the message to user2 at the second user device 108. The message may include pool#2 or pool#2 may be sent separately. In example embodiments, the second user device 108 (e.g., the communication application 112) may automatically call pool#2 in response to receiving the message (and pool#2). The service provider system 102 receives both call1 via pool#1 and call2 via pool#2. The service provider system 102 makes a determination to connect call1 and call2 (e.g., based on at least one call parameter) and connects call1 and call2.

While the embodiment of FIG. 4B shows the service provider system 102 sending the message to the user device 108 of user2, alternatively, the communication application 110 on the first user device 106 may send the message. Thus, the communication application 110 may send the message after it calls pool#1. In yet another embodiment, the communication application 120 on the first user device 106 may send the message with or after the initiation of the call to user2, and the service provider system 102 may send pool#2 any time after the sending of the message.

FIG. 4C is an example communication flow diagram for international dialing through call connections according to another alternative embodiment. The embodiment of FIG. 4C assumes that the first user device 106 has a pre-assigned pool number for calling user2. For example, when user1 initially downloaded or installed the communication application 110 on their user device 106, all international numbers in a contact list (e.g., address book) on the first user device 106 may be pre-assigned a pool number. Additionally, each time a new contact is added to the contact list or modified that is associated with an international number, a pool number may be assigned to that international number.

Accordingly, user1 initiates a call to user2 by either dialing the international number of user2 and having the communication application 110 on the first user device 106 intercept and dial pool#1, or selecting a contact entry in a contact list for user2 that automatically dials pool#1. The service provider system 102 receives call1, and in response, the service provider system 102 sends a message to user2 at the second user device 108. The message may include a second pool number (referred to as “pool#2) or pool#2 may be sent separately. In example embodiments, the user device 108 (e.g., the communication application 112) may automatically call pool#2 in response to receiving the message (and pool#2). The service provider system 102 receives call2 via pool#2 and makes a determination to connect call1 and call2 (e.g., based on at least one call parameter) and connects call1 and call2.

While the embodiment of FIG. 4C shows the service provider system 102 sending the message to the second user device 108 of user2, alternatively, the communication application 110 on the first user device 106 may send the message. Thus, the communication application 110 may send the message after it calls pool#1 in FIG. 4C in accordance with one embodiment.

FIG. 4D is an example communication flow diagram for international dialing through call connection according to a further alternative embodiment. The embodiment of FIG. 4D triggers both communication applications 110 and 112 on both user devices 106 and 108 to automatically, without user intervention, call their respective pool number in response to receiving a message. Accordingly, user1 at the first user device 106 (initiates a call to the user2. For example, user1 may dial an international number for user2 or select user2 from a contact list. An indication of the call is received by the service provider system 102. The indication may be sent, for example by the communication application 110 and include a request for a first pool number.

In response, the service provider system 102 returns pool#1 to user1. Substantially simultaneously with the receiving of the indication the service provider system 102 sends a first message to user2 at the second user device 108. The first message may include pool#2 or pool#2 may be sent separately. In example embodiments, the second user device 108 (e.g., the communication application 112) may automatically call pool#2 in response to receiving the first message (and pool#2).

In response to call2 via pool#2 being received at the service provider system 102, the service provider system 102 sends a second message to the first user device 106 of user1. The second message causes the first user device 106 (e.g., the communication application 110) to automatically call pool#1. The service provider system 102 receives call1 via pool#1 and makes a determination to connect call1 and call2 (e.g., based on at least one call parameter). Call1 is then connected to call2.

As with the other embodiments discussed above, the communication application 110 on the first user device 106 may, alternatively, send the first message to the second user device 108 of user2. Similarly, the communication application 112 on the second user device 108 of user2 may send the second message to the first user device 106 of user1. Further still, instead of providing pool#1 to user1 before sending the first message to user2, the service provider system may delay sending pool#1 until after call2 via pool#2 is received from user2 (e.g., send pool#1 substantially with the sending of the second message to user1).

FIG. 4E is an example communication flow diagram for international dialing through call connection according to another alternative embodiment. The embodiment of FIG. 4E does not answer the first call and second call until the second message is received by the first user device 106. Accordingly, user1 at the first user device 106 (initiates a call to the user2. For example, user1 may dial an international number for user2 or select user2 from a contact list. An indication of the call is received by the service provider system 102. The indication may be sent, for example by the communication application 110 and include a request for a first pool number.

In response, the service provider system 102 returns pool#1 to user1. The first user device 106 calls pool#1, but the service provider system 102 does not pick up call1 letting it ring. Substantially simultaneously with the receiving of the indication the service provider system 102 sends a first message to user2 at the second user device 108. The first message may include pool#2 or pool#2 may be sent separately. In example embodiments, the second user device 108 (e.g., the communication application 112) may automatically call pool#2 in response to receiving the first message (and pool#2). Call2 is received by the service provider system 102, but is not answered.

In response to call2 via pool#2 being received at the service provider system 102, the service provider system 102 sends a second message to the first user device 106 of user1. The second message causes the first user device 106 (e.g., the communication application 110) to send an acknowledgement that the second message was received by the first user device 106. The service provider system 102 receives the acknowledgement, and answers/picks up call1 and call2. The service provider system 102 makes a determination to connect call1 and call2 (e.g., based on at least one call parameter), and connects call1 and call2. Accordingly, the embodiment of FIG. 4E does not bill the first user or the second user for their outbound calls until such time that the first user device acknowledges the receipt of the second message.

As with the other embodiments discussed above, the communication application 110 on the first user device 106 may, alternatively, send the first message to the second user device 108 of user2. Similarly, the communication application 112 on the second user device 108 of user2 may send the second message to the first user device 106 of user1.

Further still, instead of providing pool#1 to user1 before sending the first message to user2, the service provider system may delay sending pool#1 until after call2 via pool#2 is received from user2 (e.g., send pool#1 substantially with the sending of the second message to user1). While the embodiment of FIG. 4G shows the first user device 106 requesting pool#1, alternatively, pool#1 may be pre-assigned.

FIG. 4F is an example communication flow diagram for international dialing through call connection according to another alternative embodiment. The embodiment of FIG. 4F does not answer the first call and the second call until the second user accepts the call. Accordingly, user1 at the first user device 106 (initiates a call to the user2. For example, user1 may dial an international number for user2 or select user2 from a contact list. An indication of the call is received by the service provider system 102. The indication may be sent, for example by the communication application 110 and include a request for a first pool number.

In response, the service provider system 102 returns pool#1 to user1. The first user device 106 calls pool#1, but the service provider system 102 does not pick up call1 letting it ring. Substantially simultaneously with the receiving of the indication the service provider system 102 sends a first message to user2 at the second user device 108. The first message may include pool#2 or pool#2 may be sent separately. In example embodiments, the second user device 108 (e.g., the communication application 112) may automatically call pool#2 in response to receiving the first message (and pool#2). Call2 is received by the service provider system 102, but is not answered.

The second user at the second user device 108 indicates an acceptance of the call from the first user. For example, a screen on the second user device 108 may display “incoming call from first user—accept/reject.” If the second user accepts the call, an acceptance message is sent to the service provider system 102. The service provider system 102 receives the acceptance message, and answers/picks up call1 and call2. The service provider system 102 makes a determination to connect call1 and call2 (e.g., based on at least one call parameter), and connects call1 and call2. In some embodiments, if the second user rejects the call or does not accept within a predetermined time period of receiving the message (e.g., 10 minutes), the service provider system 102 may disconnect call1 and disconnect call2. Accordingly, the embodiment of FIG. 4F does not bill the first user or the second user for their outbound calls until such time that the second user accepts the call.

As with the other embodiments discussed above, the communication application 110 on the first user device 106 may, alternatively, send the first message to the second user device 108 of user2. Further still, pool#1 may be pre-assigned.

FIG. 4G is an example communication flow diagram for international dialing through call connections according to another embodiment. User1 at the first user device 106 initiates a call to user2. For example, user1 may dial an international number for user2 or select user2 from a contact list. An indication of the call is received by the service provider system 102. The indication may be sent, for example by the communication application 110 and include a request for a first pool number.

In response, the service provider system 102 returns pool#1 to user1. The service provider system 102 receives call1 and calls the second user device 108 from a number which may be pool#2. As such, the communication application 112 on the second user device 108 may, using caller ID, identify pool#2 from the call from the service provider system 102. Therefore, the message sent to the second user device 108 in the embodiment of FIG. 4G is the call from pool#2. The communication application 112 disconnects the call from pool#2—never answering the call. In example embodiments, the second user device 108 (e.g., the communication application 112) may then automatically call pool#2. The service provider system 102 receives call2 via pool#2, makes a determination to connect call1 and call2 (e.g., based on at least one call parameter), and connects call1 and call2. While the embodiment of FIG. 4G shows the first user device 106 requesting pool#1, alternatively, pool#1 may be pre-assigned.

While various embodiments have been described in FIG. 4A-FIG. 4G, these embodiments are merely examples and embodiments of the present invention are not limited to just these. The operations of providing pool#1, pool#2, a first message, and, in some cases, a second message may be performed in different orders along with the making/receiving of calls using pool#1 and pool#2 occurring at different times during the communication flow. According the various operations of the example embodiments may be practiced in different orders so long as pool numbers are provided to respective user devices, a call is initiated by one of the users to the other, and at least one message is provided that triggers an automatic call to an assigned pool number.

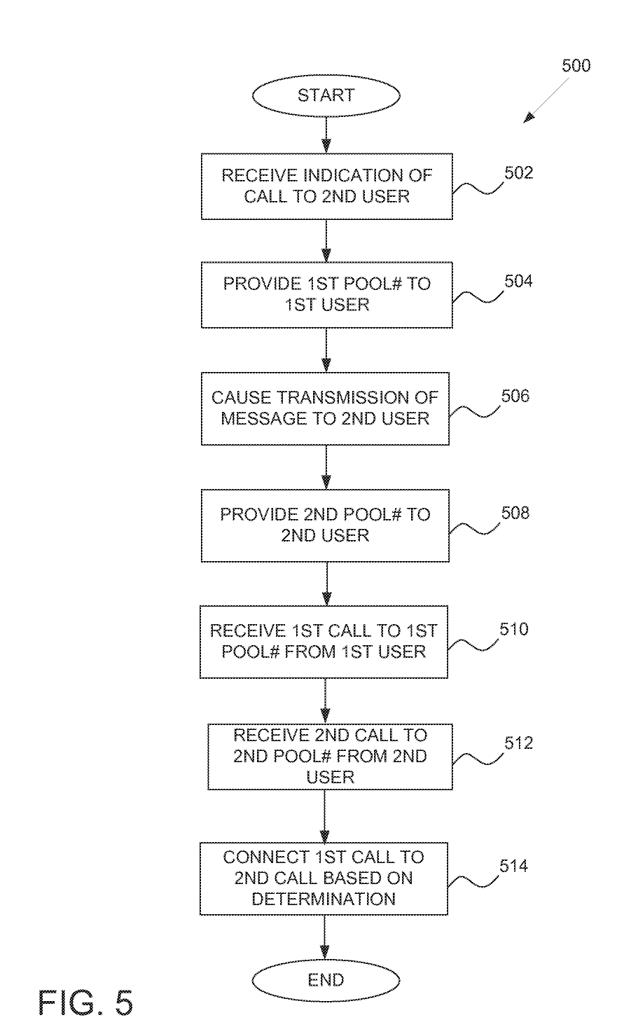

FIG. 5 is a flow diagram of an example method 500 for providing international dialing through call connections. The operations of the method 500 may occur at the service provider system 102. Accordingly, a first user at the first user device 106 initiates a call to the second user. For example, the first user may dial an international number for the second user or select the second user from a contact list. An indication of the call is received by the service provider system 102. The indication may be sent, for example by the communication application 110 and include a request for a first pool number. The indication is received in operation 502 (e.g., by the communication module 302).

In operation 504, the service provider system 102 returns a first pool number (to the first user. In example embodiments, the mapping module 304 determines the first pool number to assign to the first user. For example, the mapping module 304 may assign the first pool number in the same area code as the first user. Once the first pool number is assigned, the mapping module 304 may store the pool number along with related attributes (e.g., user identifier corresponding to the user, the corresponding international number, a time that the pool number was assigned, an expiration time for the pool number). The first pool number may then be provided via the communication module 302.

In operation 506, the service provider system 102 causes a transmission of a message to the second user at the second user device 108. In some embodiments, the message module 306 may send the message to the second user device 108 of the second user. The first message may comprise a request to the second user device 108 to initiate a call in order to be connected with the first user. In example embodiments, the request in the first message may trigger the second user device 108 (e.g., the communication application 112 to automatically call, without human intervention, a second pool number provided to the second user device 108 in operation 508. In alternative embodiments, the first message may be sent by the communication application 110 (e.g., international dialer module 202) of the first user device 106 (e.g., triggered by the receipt of the first pool number). For example, the communication application 110 on the first user device 106 may send the first message to the second user.

In some cases, the first message may include the second pool number for the second user device 108 to call. For example, the message module 306 may send both the first message and the pool number to the second user. Alternatively, the second pool number may be sent separate from the first message. For example, the communication application 110 of the first user device 106 may send the first message while the message module 306 of the service provider system 102 sends the second pool number to the second user. In either embodiment, the second pool number is obtained from the mapping module 304. The mapping module 304 may assign the second pool number in the same area code as the second user or that is the least expensive (of available pool numbers) for the second user to call. Once the second pool number is assigned, the mapping module 304 may store the second pool number along with related attributes (e.g., a user identifier corresponding to the second user, the corresponding international number, a time that the second pool number was assigned, an expiration time for the second pool number) in the mapping data store 312.

In operation 510, the service provider system 102 receives the first call via the first pool number from the first user device 106. The service provider system 102 also receives the second call via the second pool number from the second user device 108. In example embodiments, the request in the first message to the second user device 108 may trigger the second user device (e.g., the communication application 112) to automatically call, without human intervention, the second pool number provided to the second user device 108. In some embodiments, a second message sent to the first user device 106 may trigger the first user device (e.g., the communication application 110) to automatically call, without human intervention, the first pool number provided to the first user device 106.

In operation 514, the first call and the second call are connected based on a determination that these calls are to be connected. In example embodiments, the connection module 310 manages the connection of calls received via pool numbers and determines whether to connect the calls. In some embodiments, the connection module 310 may determine, receive, or extract at least one call parameter associated with at least one of the first call of the second call. The call parameter is then used to map the first call to a second call from the second user. The call parameter may include, for example, the user identifier of the first user, the user identifier of the second user, the first pool number of the first call, and the second pool number of the second call. Using at least one of these call parameters, the connection module 310 may access the mapping data store 312 to determine a mapping for the first call to the second call. In some embodiments, the call parameters may be determined from DTMF tones received with the first call and/or the second call. In other embodiments, the call parameters may be determined from data received from the communication application (e.g., communication application 110).

As discussed with respect to the example embodiments of FIG. 4A-FIG. 4D, the operations of the method 500 may be performed in a different order. For example, the first pool number may be pre-assigned (operation 504) before the receiving of the indication of the call to the second user (operation 502). Additionally, the second pool number may be provided (operation 508) before the transmission of the message to the second user (operation 506) or in the message to the second user. Furthermore, the second call via the second pool number (operation 512) may be received before the first call via the first pool number (operation 510) is placed.

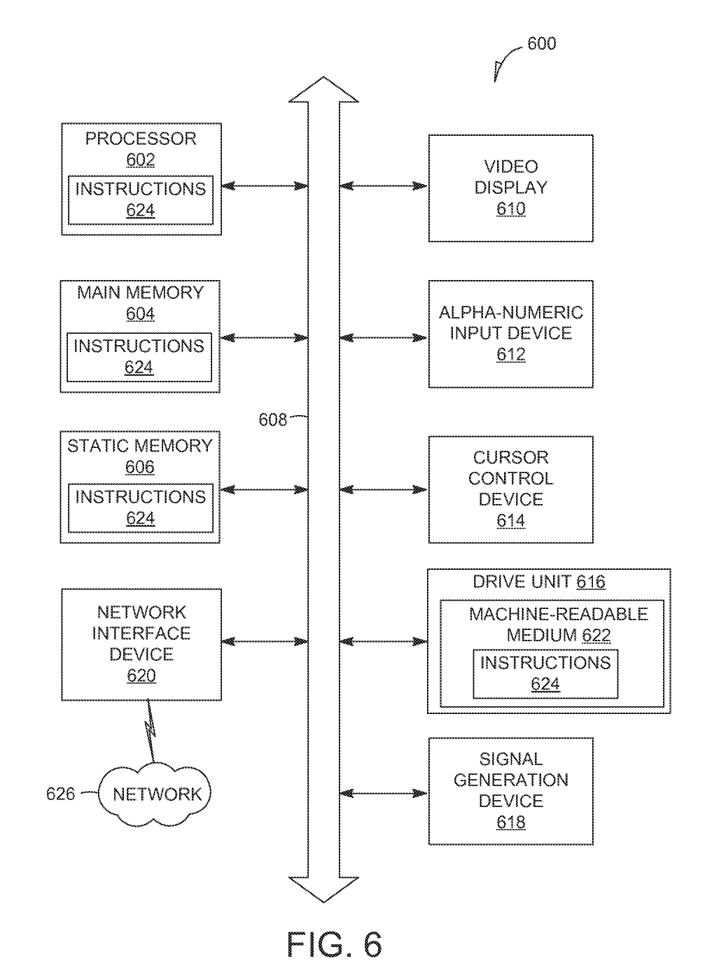

FIG. 6 is a block diagram illustrating components of a machine 600, according to some example embodiments, able to read instructions from a machine-readable medium (e.g., a machine-readable storage medium) and perform any one or more of the methodologies discussed herein. Specifically, FIG. 6 shows a diagrammatic representation of the machine 600 in the example form of a computer system and within which instructions 624 (e.g., software, a program, an application, an applet, an app, or other executable code) for causing the machine 600 to perform any one or more of the methodologies discussed herein may be executed. In alternative embodiments, the machine 600 operates as a standalone device or may be connected (e.g., networked) to other machines. In a networked deployment, the machine 600 may operate in the capacity of a server machine or a client machine in a server-client network environment, or as a peer machine in a peer-to-peer (or distributed) network environment. The machine 600 may be a server computer, a client computer, a personal computer (PC), a tablet computer, a laptop computer, a netbook, a set-top box (STB), a personal digital assistant (PDA), a cellular telephone, a smartphone, a web appliance, a network router, a network switch, a network bridge, or any machine capable of executing the instructions 624, sequentially or otherwise, that specify actions to be taken by that machine. Further, while only a single machine is illustrated, the term “machine” shall also be taken to include a collection of machines that individually or jointly execute the instructions 624 to perform any one or more of the methodologies discussed herein.

The machine 600 includes a processor 602 (e.g., a central processing unit (CPU), a graphics processing unit (GPU), a digital signal processor (DSP), an application specific integrated circuit (ASIC), a radio-frequency integrated circuit (RFIC), or any suitable combination thereof), a main memory 604, and a static memory 606, which are configured to communicate with each other via a bus 608. The machine 600 may further include a graphics display 610 (e.g., a plasma display panel (PDP), a light emitting diode (LED) display, a liquid crystal display (LCD), a projector, or a cathode ray tube (CRT)). The machine 600 may also include an alpha-numeric input device 612 (e.g., a keyboard), a cursor control device 614 (e.g., a mouse, a touchpad, a trackball, a joystick, a motion sensor, or other pointing instrument), a storage unit 616, a signal generation device 618 (e.g., a speaker), and a network interface device 620.

The storage unit 616 includes a machine-readable medium 622 on which is stored the instructions 624 embodying any one or more of the methodologies or functions described herein. The instructions 624 may also reside, completely or at least partially, within the main memory 604, within the processor 602 (e.g., within the processor's cache memory), or both, during execution thereof by the machine 600. Accordingly, the main memory 604 and the processor 602 may be considered as machine-readable media. The instructions 624 may be transmitted or received over a network 626 via the network interface device 620.

As used herein, the term “memory” refers to a tangible machine-readable medium able to store data temporarily or permanently and may be taken to include, but not be limited to, random-access memory (RAM), read-only memory (ROM), buffer memory, flash memory, and cache memory. While the machine-readable medium 622 is shown in an example embodiment to be a single medium, the term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions for execution by a machine (e.g., machine 600), such that the instructions, when executed by one or more processors of the machine (e.g., processor 602), cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory, an optical medium, a magnetic medium, or any suitable combination thereof.

Furthermore, the machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 624 may further be transmitted or received over a communications network 626 using a transmission medium via the network interface device 620 and utilizing any one of a number of well-known transfer protocols (e.g., HTTP). Examples of communication networks include a local area network (LAN), a wide area network (WAN), the Internet, mobile telephone networks. POTS networks, and wireless data networks (e.g., WiFi and WiMAX networks). The term “transmission medium” shall be taken to include any intangible medium that is capable of storing, encoding, or carrying instructions for execution by the machine, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a field programmable gate array (FPGA) or an ASIC. A hardware module may also include programmable logic or circuitry that is temporarily configured by software to perform certain operations. For example, a hardware module may include software encompassed within a general-purpose processor or other programmable processor. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, a processor being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an application program interface (API)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Although an overview of the inventive subject matter has been described with reference to specific example embodiments, various modifications and changes may be made to these embodiments without departing from the broader scope of embodiments of the present invention. Such embodiments of the inventive subject matter may be referred to herein, individually or collectively, by the term “invention” merely for convenience and without intending to voluntarily limit the scope of this application to any single invention or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present invention. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present invention as represented by the appended claims. The specification and drawings are, accordingly, to be regarded in an illustrative rather than a restrictive sense.

What is claimed is:

1. A method comprising:
receiving an indication of an initiation of a call by a first user to a second user;
providing a first pool number to a first user device of the first user, the first pool number being different from a phone number of the second user;
causing transmission of a message to a second user device of the second user that causes the second user device to automatically initiate a call to a second pool number without any action by the second user, the second pool number being different from a phone number of the first user;
receiving a first call from the first user via the first pool number and a second call from the second user via the second pool number; and
picking up and connecting, using a hardware processor, the first call and the second call at a server.

2. The method of claim 1, wherein the message triggers a request to the second user to accept the call from the first user; and the method further comprising:
receiving an acceptance message from the second user indicating that the second user accepts the call from the first user, the receiving the acceptance message triggering the server to pick up and connect the first call and the second call.

3. The method of claim 1, further comprising:
causing transmission of a second message to the first user device; and
receiving an acknowledgement from the first user device indicating the second message was received at the first user device, the receiving the acknowledgement triggering the server to pick up and connect the first call and the second call.

4. The method of claim 1, further comprising determining, based on a call parameter and using a hardware processor, that the first call from the first user and the second call from the second user are to be connected.

5. The method of claim 4, further comprising determining the call parameter based on DTMF tones received from at least one of the first call or the second call, the DTMF tones providing data that maps the first call to the second call

6. The method of claim 4, further comprising determining the call parameter based on data received from a communication application of a device of at least one of the first user or the second user, the data from the communication application used to map the first call to the second call

7. The method of claim 4, further comprising mapping a first identifier of the first user to at least one of a second identifier of the second user or the second pool number, wherein the call parameter comprises the first identifier of the first user received with the first call and at least one of the second identifier of the second user received with the second call or the second pool number of the second call.

8. The method of claim 4, further comprising mapping a second identifier of the second user to at least one of a first identifier of the first user or the first pool number, wherein the call parameter comprises the second identifier of the second user received with the second call and at least one of the first identifier of the first user received with the first call or the first pool number of the first call.

9. The method of claim 1, further comprising assigning at least one of the first pool number or the second pool number to a plurality of other users for a plurality of other calls.

10. The method of claim 1, wherein the initiation of the call comprises a selection from the group consisting of: the first user initiating the call to the phone number of the second user, a communication application on the device of the first user fetching the first pool number, and the communication application on the device of the first user initiating the call to the first pool number instead of the phone number of the second user.

11. The method of claim 1, wherein the first pool number is located in a first calling area that has a low cost for the first user and the second number is located in a second calling area that has a low cost for the second user.

12. The method of claim 1, wherein causing the transmission of the message to the second user device comprises a selection from the group consisting of:
causing the transmission of the message using SMS;
causing the transmission of the message using a phone call; and
causing the transmission of the message to a communication application of the second user device in response to detecting a presence of the communication application on the second user device of the second user.

13. The method of claim 1, wherein the providing the first pool number to the first user occurs before the receiving of the indication of the initiation of the call by the first user.

14. The method of claim 1, wherein the second pool number is contained in the message.

15. The method of claim 1, wherein the transmission of the message takes place before the first user initiates the first call.

16. The method of claim 1, wherein the transmission of the message takes place after the first user initiates the first call.

17. The method of claim 1, wherein the transmission of the message takes place from at least one of the first user device or a server.

18. The method of claim 1, wherein causing the transmission of the message to the second user device comprises calling the second user device from a second pool number, the second user device to disconnect from a call from the second pool number and to initiate the second call to the second pool number.

19. A non-transitory machine-readable medium in communication with at least one processor, the non-transitory machine-readable medium storing instructions which, when executed by the at least one processor of a machine, cause the machine to perform operations comprising:
receiving an indication of an initiation of a call by a first user to a second user;
providing a first pool number to a first user device of the first user, the first pool number being different from a phone number of the second user;
causing transmission of a message to a second user device of the second user that causes the second user device to automatically initiate a call to a second pool number without any action by the second user, the second pool number being different from a phone number of the first user;
receiving a first call from the first user via the first pool number and a second call from the second user via the second pool number; and
picking up and connecting the first call and the second call.

20. A system comprising:
a hardware processor;
a communication module to receive an indication of an initiation of a call by a first user to a second user;
a mapping module to provide a first pool number to a first user device of the first user, the first pool number being different from a phone number of the second user and to provide a second pool number to a second user device of the second user, the second pool number being different from a phone number of the first user;
a messaging module to cause transmission of a message to the second user that causes the second user device to automatically initiate a call to the second pool number without any action by the second user,
the communication module to receive a first call from the first user device via the first pool number and a second call from the second user device via the second pool number, and
a connection module to pick up and connect, using the hardware processor, the first call and the second call.
